(19) United States
(12) Patent Application Publication
(10) Pub. No.: US 2006/0162202 A1
(43) Pub. Date: Jul. 27, 2006

(54) Illuminated foldable module and display system

(76) Inventor: Robert Landry, Charlesbourg (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/357,956

(22) Filed: Feb. 22, 2006

Related U.S. Application Data
(63) Continuation-in-part of application No. 11/214,926, filed on Aug. 31, 2005, now abandoned.
Application No. 11/214,926 is a continuation of application No. PCT/CA04/00327, filed on Mar. 4, 2004.
(60) Provisional application No. 60/451,273, filed on Mar. 4, 2003.

(51) Int. Cl. G09F 13/00

(52) U.S. Cl. 40/541

(57) ABSTRACT

A foldable module adapted to be illuminated includes a foldable panel arranged to be positioned between a folded position and a deployed position. at least one light source is mounted to the panel for shedding light. The light source remains on the foldable panel in the folded and deployed positions. The foldable module can also include a mechanical system that permits to removably mount a display poster to the panel.

### CROSS-REFERENCE TO RELATED APPLICATIONS

This application is a continuation-in-part of US patent application Ser. No. 11/214,926 filed Aug. 31, 2005, now pending, which in turn is a continuation of PCT patent application serial number PCT/CA2004/000327, designating the United States, filed Mar. 4, 2004 which claimed priority of U.S. provisional patent application 60/451,273 filed on Mar. 4, 2003, the specifications of which are incorporated herein by reference.

### FIELD OF THE INVENTION

The invention relates to a foldable module adapted to be illuminated and in particular to a foldable lighting module adapted to receive a display poster thereon and backlightening the latter. It also relates to a rollable lighting kit.

### DESCRIPTION OF THE PRIOR ART

Nowadays, the pace of work and its growing mobility force us to find solutions that save time, money, and space. Companies are constantly looking for new products which would allow them to get in front of their competitors and highlight their existing products. Among the marketing tools available to the exhibitors, display modules represent certainly a key element of the presentation of companies or of their products to the public. However, the numerous handlings required to travel from an exhibition or a colloquium to another one often limit the exhibitors in the choice of their advertising medium. Therefore, they are interested in light and compact tools. Moreover, the time required to install an advertising medium is frequently a critical variable for the choice of a marketing tool.

Several compact stand systems, which are easy to carry and to install, are presently available. However, these stands offer a limited visual effect because they frequently consist of images on backcloths which require direct lightening with systems which can damage the ad's visibility by causing unpleasant catch lights.

To reduce these inconveniences, backlightened systems were conceived. Although these systems have the known advantages of attracting the consumer's attention and of avoiding unwanted catch lights, these systems are heavy, expensive, and difficult to carry and to install. Companies rarely choose to use these in temporary settings such as trade shows because of these limitations.

Therefore, it would be highly desirable to combine the advantages of compact systems and those of backlightened systems to obtain a backlightened support easy to carry and to install.

Furthermore, portable or temporary, variable and intense lightening is often needed in applications such as, without being limitative, photography, greenhouses, roadside assistance, construction, emergency services and the like. The existing systems are expensive, complex and difficult to carry. Moreover, the rigidity of the current lightening systems makes them non-versatile and limited to the small effects that one can create with a light beam.

### BRIEF SUMMARY OF THE INVENTION

It is therefore an aim of the present invention to address the above mentioned issues.

Accordingly, an aspect of the improvements is to provide a foldable module adapted to be illuminated which can be folded or rolled into a compact configuration to facilitate transportation and storage, but still can be deployed rapidly into an operative configuration.

It is another aspect of the improvements to provide a foldable module adapted to be illuminated and on which a display poster can be removably mounted and backlightened.

An aspect of the improvements provides a foldable module adapted to be illuminated. The foldable module comprises: a foldable panel having a folded position allowing the panel to be stored and transported and a deployed position; and at least one light source mounted to the panel for shedding light, the at least one light remaining on the foldable panel in the folded and deployed positions.

Another aspect of the improvements provides a method to display a poster. The method comprises: extending a lighting module including a pliable panel with at least one light source mounted thereto from a compacted position to a deployed position exposing the at least one light source; mounting a display poster on the lighting module in the deployed position; and connecting the at least one light source to a power supply for illuminating the display poster mounted to the lighting module.

A further aspect of the improvements provides a method for lightening an area. The method comprises: extending a lighting module including a pliable panel with at least one light source mounted thereto from a compacted configuration to an operative configuration exposing the at least one light source; and connecting the at least one light source to a power supply for shedding light from lighting module.

Another aspect of the improvements provides a foldable lighting kit, which comprises: at least two laths connectable to one another and defining, when connected together, a compactable panel movable between a compacted position and a deployed position; and at least one light connector mounted to the compactable panel and movable therewith between the compacted position and the deployed position.

Another aspect of the improvements provides a lighting module, which comprises a rollable panel having at least one light connector mounted thereto and being rollable onto itself for storage and transportation purposes and unrollable in an operative configuration exposing the at least one light connector.

The terms “pliable” and “compactable” as used herein means foldable, rollable, and condensable along either or both the length and the width of the lighting module to provide a reduction of its size.

### BRIEF DESCRIPTION OF THE DRAWINGS

FIG. 1 is a front elevation view of a foldable lighting module adapted to be illuminated in accordance with an embodiment of the invention, wherein a display poster is mounted thereon;

FIG. 2 is a top plan view of the foldable lighting module of FIG. 1;

FIG. 3 is a side elevation view, fragmented, of the foldable lighting module of FIG. 1 with the display poster removed;

FIG. 4 is a perspective view, fragmented, of a lath of the foldable lighting module of FIG. 1 in accordance with an embodiment of the invention;

FIG. 5 is a front elevation view, fragmented, of laths in accordance with another embodiment of the invention;

FIG. 6 is a side elevation view, fragmented and enlarged, of a securing system for mounting a display poster on a foldable lighting module in accordance with an embodiment of the invention;

FIG. 7 is a perspective view of a foldable lighting module, in a deployed position, adapted to be illuminated in accordance with another embodiment of the invention;

FIG. 8 is a perspective view of the foldable lighting module of FIG. 7, in a folded position;

FIG. 9 is a side elevation view of a hinge mechanism for connecting two laths together in accordance with an embodiment of the invention;

FIG. 10 is a front elevation view of a foldable lighting module, in a deployed position, in accordance with another embodiment of the invention;

FIG. 11 is a front elevation view, enlarged and fragmented, of the foldable lighting module of FIG. 10;

FIG. 12 is a front elevation view of a light connector lath of the foldable lighting module shown in FIG. 10 in accordance with an embodiment of the invention;

FIG. 13 is a perspective view of the light connector lath shown in FIG. 12;

FIG. 14 is a side elevation view of the light connector lath shown in FIG. 12 with a flexible material sheet engaged therewith in accordance with an embodiment of the invention;

FIG. 15 is a side elevation view of the light connector lath shown in FIG. 12 with flexible material sheets engaged therewith in accordance with another embodiment of the invention;

FIG. 16 is a side elevation view a light connector lath of the foldable lighting module shown in FIG. 10 in accordance with another embodiment of the invention;

FIG. 17 is a side elevation view of the foldable lighting module shown in FIG. 10 in a folded position;

FIG. 18 is a front elevation view, fragmented and enlarged, of a foldable lighting module, in a deployed position, in accordance with another embodiment of the invention;

FIG. 19 is a side elevation view of a light connector lath of the foldable lighting module shown in FIG. 18 with flexible material sheets engaged therewith in accordance with an embodiment of the invention; and

FIG. 20 is a side elevation view of a light connector lath of the foldable lighting module shown in FIG. 18 with a flexible material sheet engaged therewith in accordance with another embodiment of the invention.

It will be noted that throughout the appended drawings, like features are identified by like reference numerals.

### DETAILED DESCRIPTION OF THE PREFERRED EMBODIMENTS

Embodiments of the invention will now be described with reference to the drawings wherein like numerals refer to like parts.

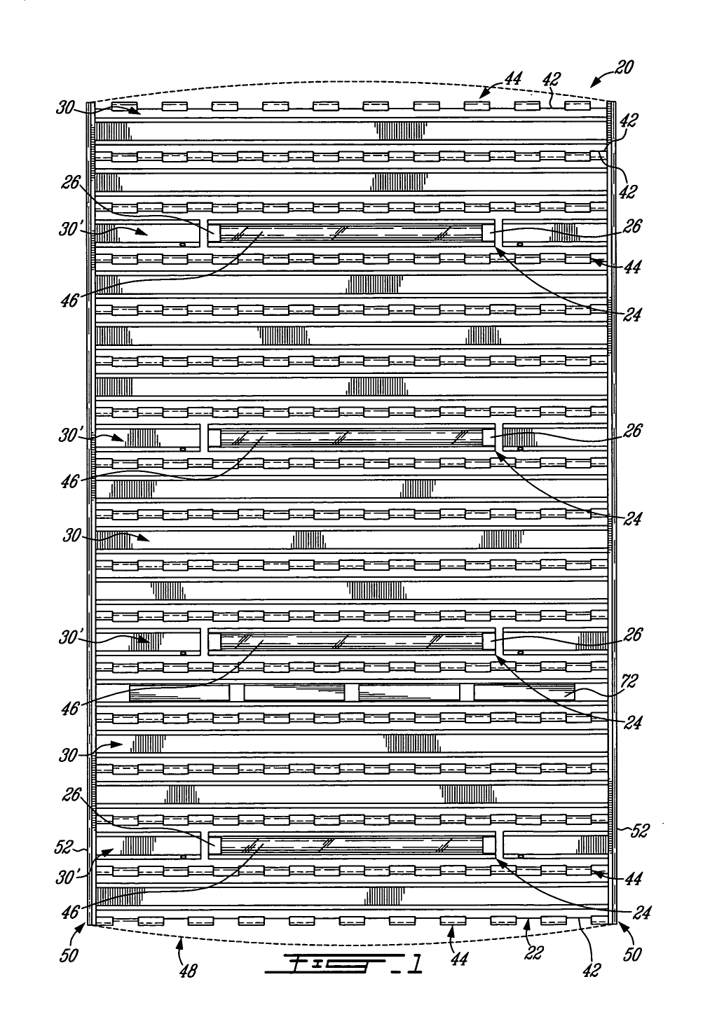

Referring to FIG. 1, it will be seen that a foldable lighting module 20 which includes a foldable panel 22, or pliable, compactable panel, and a lightening system 24 mounted to the panel 22 by means of connecting members 26, or light connectors, as it will be described in more detail below.

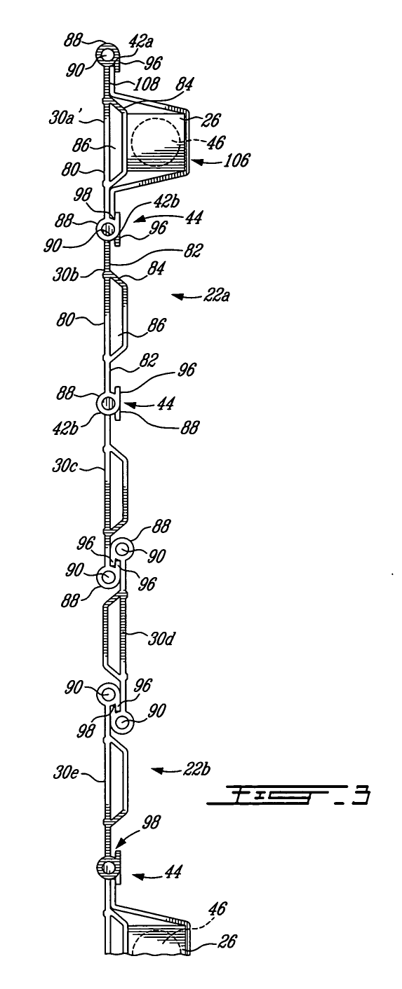

Referring simultaneously to FIGS. 1 and 4, it will be seen that the panel 22 includes a plurality of laths 30, each having two transversal edges 42. At least one transversal edge 42 of the laths 30 is juxtaposed to a transversal edge of an adjacent lath 30 and connected thereto by means of hinges 44. Hinges 44 permit both adjacent laths 30 to pivot relatively to one another to allow for the panel 22 to be folded into a compact or folded state to facilitate handling, as it will be described in more detail below. Hinges 44 may be any type of hinge mechanism known to one skilled in the art. Several embodiments of hinges 44 will be described in more detail below. Laths 30 are assembled to juxtaposed laths 30 with hinges 44 until the desired panel length is achieved. Hinges 44 can be adapted to allow a modification of the length of the panel 22 by adding or removing laths 30 in accordance with the user's needs.

In the embodiment shown in FIGS. 1 to 4, laths 30 can be formed from a thin rigid material such as plastic, a sheet metal such as aluminum, or the like. The shape, the material and the dimensions of the laths 30 vary in accordance with the user's needs or the intended application. Typically, the laths 30 are made by an extruding or molding process to reduce production costs.

In FIG. 1, the lightening system 24 includes fluorescent tubes 46 mounted to the laths 30. As mentioned above, light connectors 26 are mounted to the panel 22 or, more particularly, the laths 30 to provide the lightening system 24. Therefore, the laths 30 having light connectors 26 mounted thereto are light-bearing laths 30′, or light source equipped laths 30′.

Depending on the desired effect, the number of fluorescent tubes 46 in the lightening system 24 can vary. Depending on the desired light output and on the desired length of the panel 22, the number of plain laths 30 and light source equipped laths 30′ in the panel 22 can vary.

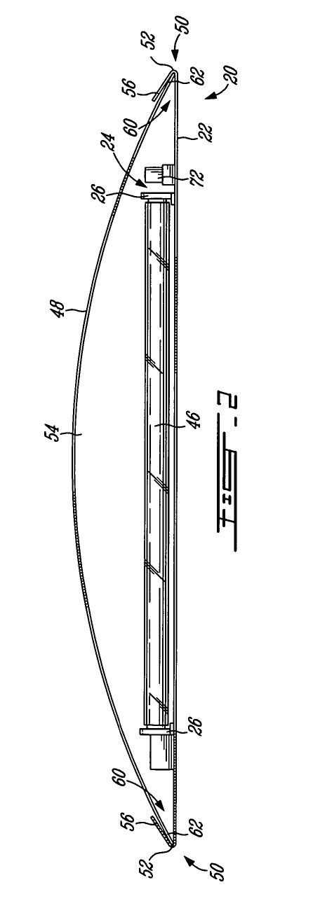

Referring simultaneously to FIGS. 1 and 2, it will be seen that for advertising purposes, the foldable lighting module 20 can be transformed into a display system by removably mounting a display poster 48 in front of the panel 22. The poster 48 is engaged into a poster securing member 50 (or display poster connector) located on two opposite edges 52 of the panel 22. A person skilled in the art will appreciate that different securing members 50 can be used. Two of them will be described in more detail below.

The poster 48 can be manufactured from a flexible material, especially a transparent flexible plastic to allow the light generated by the lightening system 24 to go through the poster 48. The poster opacity can be adapted in accordance with the desired effect. A more uniform light distribution is obtained with a more opaque material while a higher brightness is obtained with a more transparent poster. One skilled in the art would understand that the advertising messages can be directly written on the poster 48 or on another distinct support or advertising medium such as slides (not shown) which are mounted to the poster 48 with an adhesive or a fastener.

Referring again simultaneously to FIGS. 1 and 2, it will be seen that the poster 48 is wider than the panel 22 and adopts an arcuate shape when secured to the panel 22 with the securing member 50. The arcuate shape creates a space 54 between the panel 22 and the poster 48 that favours uniform light dispersion. The lightening system 24, which in the present embodiment includes fluorescent tubes 46, is located in the space 54 between the panel 22 and the poster 48. The space 54 also eliminates heat accumulation resulting from the lightening system 24. For esthetic reasons, the panel 22 and the poster 48 can have the same height.

In FIG. 2, the poster securing member 50 includes two inwardly turned edges 56 located on the longitudinal edges 58 of the laths 30, which constitute the opposite edges 52 of the panel 22. The assembly of turned edges 56 and flat portion of the lath 30 proximate to the turned edge 56 creates a V-shape 60 in which an edge 62 of the poster 48 is inserted. Two opposite edges 62 of the poster 48 are inserted in the opposite V-shapes 60 and are forcedly maintained therein since the poster 48 is wider than the panel 22 and has an arcuate shape when secured to the panel 22. The poster securing member 50 can be continuous along the edges 52 of the panel 22 or it can include a plurality of V-shapes 60 located on each or several laths 30 along the edges 52. As it will be appreciated by one skilled in the art, securing member 50 can be located on any pair of opposite edges 52 of the panel 22. The poster 48 can be inserted at one extremity of the panel 22 to slide into the V-shapes 60 until the poster 48 is in the desired position on the panel 22. As seen of FIG. 5, the turned edges 56 can have a trapezoidal shape to facilitate the folding of the panel 22 into the folded position.

The lightening system 24 includes a starter (not shown), ballasts 72, which are a special sort of transformer, and fluorescent tubes 46. The fluorescent tubes 46 are mounted to the laths 30 between two connecting members 26, which are either glued to, welded to, extruded with or fastened to the laths 30. The fluorescent tubes 46 are disposed transversally on the laths 30 and are either connected in series or in parallel. The starter, the ballasts 72, and the fluorescent tubes 46 are operatively connected together with wires (not shown). A power cable (not shown) associated with electric outlets (not shown) provides power to the lightening system 24. To provide an optimal lightening and allow the module 20 to be easily folded, the fluorescent tubes 46 can be uniformly disposed on the laths 30. For example, a fluorescent tube 46 can be disposed every three laths. A power plug (not shown) for the fluorescent tubes 46 is mounted inwardly on each connecting member 26 and is operatively connected to the wire. Pins (not shown) of the fluorescent tubes 46 are inserted into the power plugs for electrical contact and mounting fluorescent tubes 46 to panel 22. It would be understood by someone skilled in the art that the fluorescent tubes 46 could be disposed at a narrower or wider interval and that the starter and ballasts 72 could be positioned anywhere either on the panel or on a separate member. Moreover, the lightening system 24 can be provided with more than one starter or with bulbs (not shown) or any other types of lights (or light sources) such as light-emitting diodes (LEDs) instead of the fluorescent tubes 46. Furthermore, the lightening system 24 can be designed to operate at different electrical input voltages, both AC and DC.

FIGS. 3 and 4 show a first hinge 44 that allows a first lath 30′a to pivot relatively to a second lath 30b juxtaposed to the lath 30′a. Similarly, laths 30b and 30c pivot together and the two hinges 44 being identical, only one will be described in details, i.e. the one connecting laths 30′a and 30b. It will be seen that laths 30′a, 30b, 30c, 30d, and 30e have a flat back surface 80, a front surface 82 with a protruding member 84 having a channel 86 therein, and two transversal edges 42a, 42b with hinge members 88 extending therefrom. The hinge members 88 have a bore 90 extending transversally thereinto. The channel 86 inside the protruding member 84 is used to hide the wires of the lightening system 24. The wires can then provide power to the lightening system 24 without being seen from the user while reducing the probability of accidental wire damage. The connecting members 26, or light connectors, for the fluorescent tubes 46 are disposed on the protruding member 84. A plurality of hinge members 88 are disposed alternatively on both transversal edges 42a, 42b of the laths 330a, 30b. The hinge members 88 on the laths 30a, 30b, 30c, 30d, and 30e are identical, and therefore only one will be described. Along a transversal edge 42a, each hinge member 88 is separated from the nearest hinge member 88 by a hollow space 92. Therefore, the hinge members 88 and the hollow spaces 92 alternate on the transversal edge 42a. In an embodiment, the hinge members 88 and the hollow spaces 92 have the same length. On the opposite transversal edge 42b, the hinge members 88 and the hollow spaces 92 are disposed in a similar alternate manner. However, a hinge member 88 on the transversal edge 42a faces a hollow space 92 on the transversal edge 42b and vice-versa. The laths 30a, 30b are assembled by inserting a hinge member 88 of lath 30a into a hollow space 92 of lath 30b and vice-versa. The bores 90 of hinge members 88 on the transversal edge 42b of the lath 30a face the bores 90 of the hinge members 88 on the transversal edge 42a of the lath 30b juxtaposed to the lath 30a and form a continuous channel in which a rod (not shown) is inserted. The rod maintains the laths 30a, 30b together and allows a pivoting movement of both laths 30a, 30b relatively to one another. The hinge 44 can be located either all along or on a portion only of the transversal edges 42a, 42b of the laths 30a, 30b, 30c, 30d, and 30e.

Also, the hinge member 88 has a tooth 96 extending inwardly therefrom toward the center of the lath 30. The combination of the tooth 96, the hinge member 88, and the front surface 82 forms a hook 98. The hook 98 can be used to join two panels 22a, 22b together. Referring to FIG. 3, it will be seen that the panel 22a having a end lath 30c is joined to the panel 22b having a end lath 30e through lath 30d. Lath 30d is positioned between laths 30c and 30e and in the opposite direction in a manner such that the hooks 88 of juxtaposed transversal edges 42 of laths 30c and 30d are inserted into each other and, similarly, the hooks 98 of juxtaposed transversal edges 42 of the laths 30d and 30e are inserted into each other and maintain the panels 22a and 22b together. The hooks 98 make it possible to easily and rapidly modify the length of the lighting module 20.

Still referring to FIGS. 3 and 4, a protection member 106 can be positioned over the fluorescent tube 46 to reduce the risk of breakage while manipulating the module 20. The protection member 106 includes a rigid transparent plastic having a trapezoidal shape mounted to the lath 30 over the fluorescent tube 46. The edges 108 of the protection member 106 are inserted into the hooks 98 of the laths 30. The shape (trapezoidal, semi-circular, square, etc.), the material and mounting method (fastened, glued, inserted, engaged, etc.) of the protection member 106 could be modified as it will be appreciated by a person skilled in the art.

Referring to FIG. 5, another embodiment of the laths 32, 34 will be seen wherein the features are numbered with reference numerals in the 100 series which correspond to the reference numerals of the previous embodiment. In FIG. 5 a first lath 130a pivots relatively to a second lath 130b, juxtaposed to the lath 130a, through hinge 144. The hinge 144 includes a J-shape member 112 protruding from a first transversal edge 142a and a recess 114 having a protruding hook portion (not shown) located on the second transversal edge 142b, opposite to the transversal edge 142a. The J-shape member 112 and the recess 114 face each other. To assemble the laths 130a and 130b, the J-shape member 112 of lath 130b is inserted into the hook portion of the recess 114 of the lath 130a. To obtain a strong lath assembly, the transversal edges 142 of the laths 130a, 130b can include more than one hinge 144.

The hinge 144 could also include a J-shape member 112 protruding from a first transversal edge 142a and a slot (not shown) located above the second transversal edge 142b and below J-shape member 112. This will allow J-shape member 112 of lath 130b to be inserted into the slot of a second lath 132 juxtaposed to lath 130b when laths 130a, 130b are assembled together. Laths 130a, 130b can include more than one hinge 144.

Hinge 44, 144 can also include at least one plastic band (not shown) mounted longitudinally to the laths 30, 130. The plastic band is used to assemble the laths 30, 130 together and allows the panel 22, 122 to be in either a folded state or a deployed state by permitting a pivoting movement of the laths 30, 130 relatively to one another.

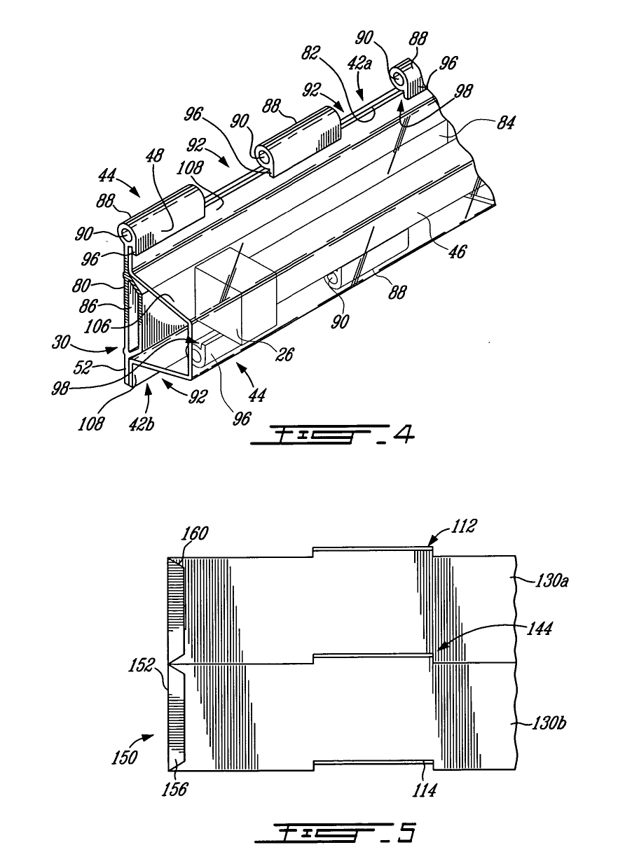

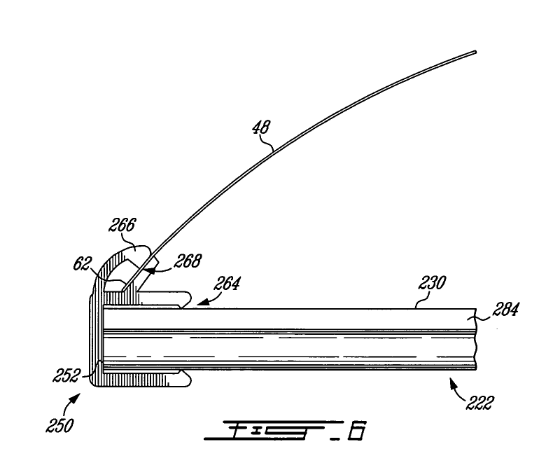

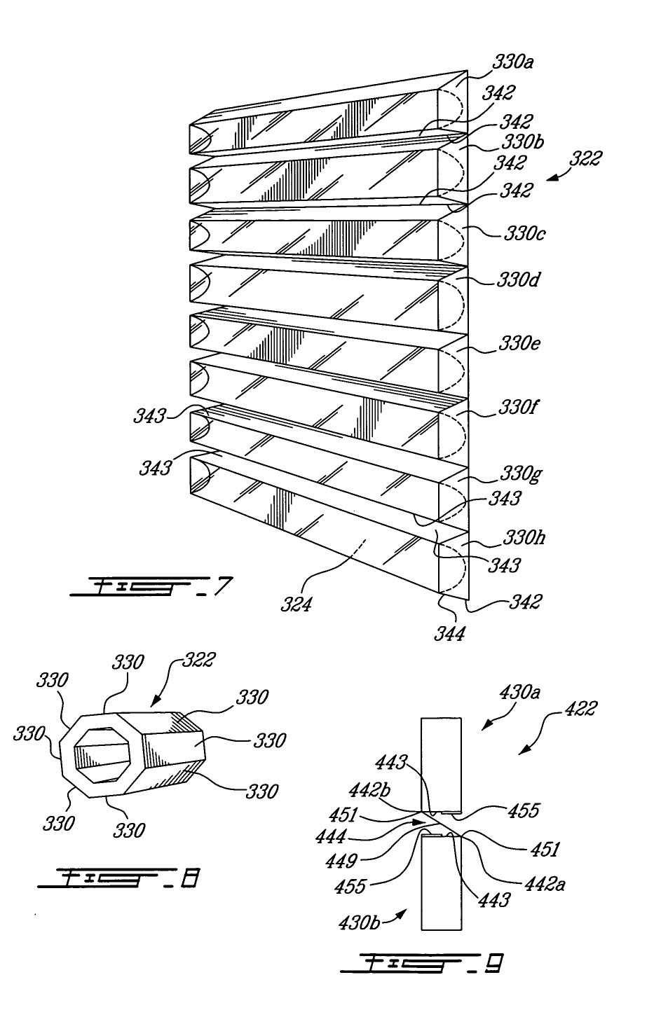

Referring to FIG. 6, another embodiment of the poster securing member 50 will be seen wherein the features are numbered with reference numerals in the 200 series which correspond to the reference numerals of the previous embodiments. The poster securing member 250 engages one longitudinal edge 252 of the panel 222 over the laths 230. The securing member 250 has an engaging portion 264 that is engaged over the edge 252 and a clamp 266 that has a narrow groove 268 therein in which the edge 62 of the poster 48 is inserted. The orientation of the clamp 266 relatively to the engaging portion 264 determines the curvature of the poster 48. If the securing member 250 is continuous along the edge 252 of the panel 222 and is engaged with the laths 230, perpendicularly to the latter, the securing member 250 stiffens the panel 222 in a deployed state. The securing members 250 have to be removed from the edges 252 of the panel 222 before moving the panel 222 between a deployed state to a folded or rolled state. A person skilled in the art will appreciate that other securing members such as an adhesive or mechanical fasteners could be used for mounting the poster 48 to the panel 222. Referring to FIGS. 7 and 8, another embodiment of the foldable lighting module 20, 120, 220 will be seen wherein the features are numbered with reference numerals in the 300 series which correspond to the reference numerals of the previous embodiments. The foldable panel 322 includes a plurality of lath members 330a, 330b, 330c, 330d, 330e, 330f, 330g, 330h. As for the panels 22, 122, 222, each panel 322 has two transversal edges 342 and at least one transversal edge 342 of the lath member 330 is juxtaposed to a transversal edge 342 of an adjacent lath member 330 and connected thereto by means of hinges (not shown). The hinges permit both adjacent laths 330 to pivot relatively to one another to allow for the panel 322 to be folded into a compact or folded state, as shown in FIG. 9, to facilitate handling. The lath members 330 have two transversal lateral edge surfaces 343 that are inwardly beveled to facilitate the folding of the panel 322. The lightening system 324 is disposed into the lath members 330 and provides illumination therein and sheds light therefrom.

Referring now to FIG. 9, another embodiment of the foldable panel 22, 122, 222, 322 will be seen wherein the features are numbered with reference numerals in the 400 series which correspond to the reference numerals of the previous embodiments. The foldable panel 422 includes a plurality of lath members 430a, 430b. As for the panel 322, the lath members 430a, 430b have two transversal lateral edge surfaces 443 that are connected to each other by means of a hinge 444. The hinge 444 includes a plate 449 having a first edge 451 pivotally connected to a transversal edge 442a of the lateral edge surface 443 of the lath 430b and a second edge 451 pivotally connected to a transversal edge 442b of the lateral edge surface 443 of the lath 430a. The transversal edges 442a, 442b are opposite to each other, therefore, the plate 449 is diagonally disposed between the laths 430a, 430b. Both lateral edge surfaces 443 have a magnet 455 mounted thereon. The magnets 455 of the laths 430a, 430b are attracted to each other and therefore strengthen the panel 422 in the unfolded or deployed position.

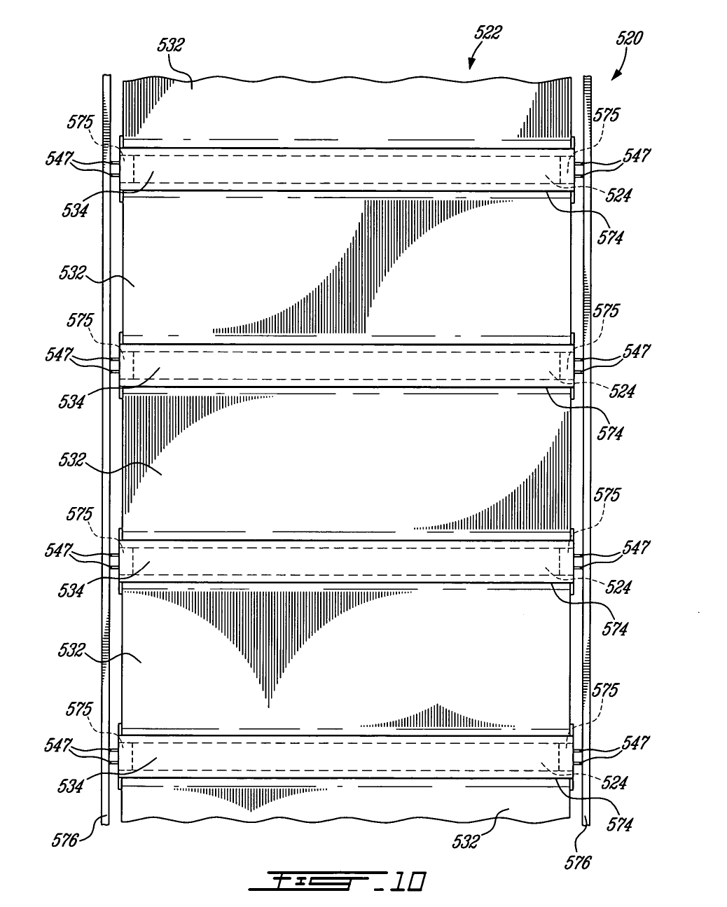

Referring now to FIGS. 10 and 11, another embodiment of the rollable/foldable lighting module 20, 120, 220, 320, 420 will be seen wherein the features are numbered with reference numerals in the 500 series which correspond to the reference numerals of the previous embodiments.

The lighting module 520 includes a plurality of flexible material strips 532, or laths, connected together through light connector strips 534, or laths. The flexible material strip(s) 532 and the light connector strip(s) 534 are connected together to define the foldable/rollable panel 522. A person skilled in the art will appreciate that the flexible material strips 532 and the light connector strips 534 can be connected in several ways. Without being limitative, several connection embodiments will be described below.

The size of the flexible material strips 532 varies in accordance with the user's needs. The flexible material can be either fabric, foil, flexible polymers such as PVC or any other material allowing the resulting panel 522 to be rolled or folded into the compact, storage, or folded position.

The light connector strips 534 are adapted to receive a light source 524 thereto. As for the embodiments described above, the light source 524 can be, without being limitative, any lightening system such as bulbs, fluorescent tubes, LED (light emitting diode), etc. The light connector strips 534 and the light sources 524 remain on the panel 522 in the folded and deployed positions of the module 520.

As for the flexible material strips 532, the size of the light connector strips 534 varies in accordance with the user's needs. For example, the light connector strips 534 can be of several materials in accordance with the user's needs. For example, they can be a light permeable plastic material extrusion.

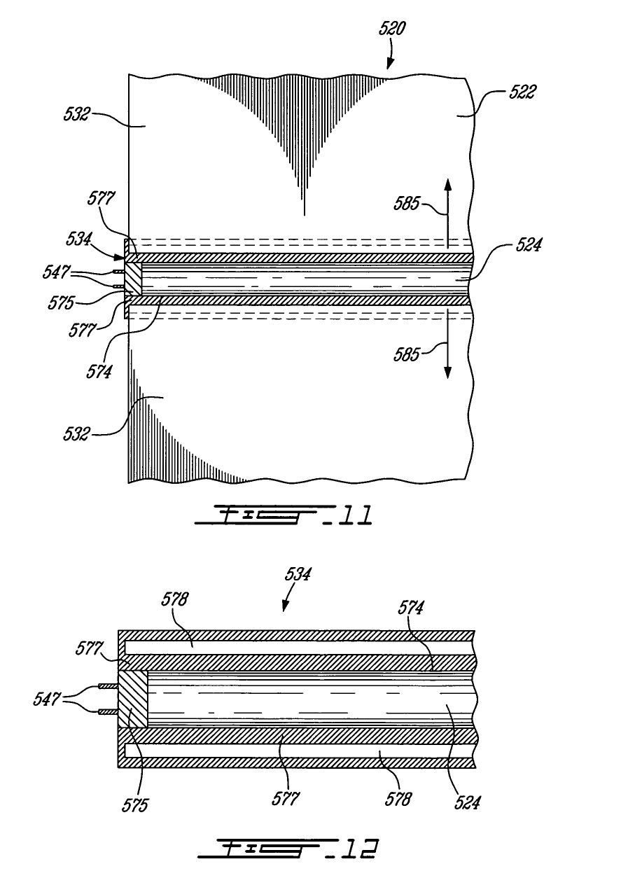

In the embodiment shown in FIGS. 11 to 13, the light connector strips 534 include a tube 574 defining a channel therein in which the light source 524 is mounted. In the embodiment shown, a fluorescent tube is mounted into the tube 574. The pins 547 of the fluorescent tubes extend outwardly of the tubes 574. The light sources 524 are maintained in the tubes 574 with caps 575 mounted at opposed ends of the tubes 574.

In the embodiment shown, power is provided to the light sources 524 through to conductive bands 576 (FIG. 10) extending on opposed sides of the panel 522. In this embodiment, power is provided simultaneously to all the light sources 524 of the module 520. However, a person skilled in the art will appreciate that power can be provided independently to each light source 524 of the module 520.

The light connector strips 534 include two opposed connection flanges 577 extending outwardly relatively to the tubes 574. The connection flanges 577 have a groove 578 therein for connection to the flexible material strips 532.

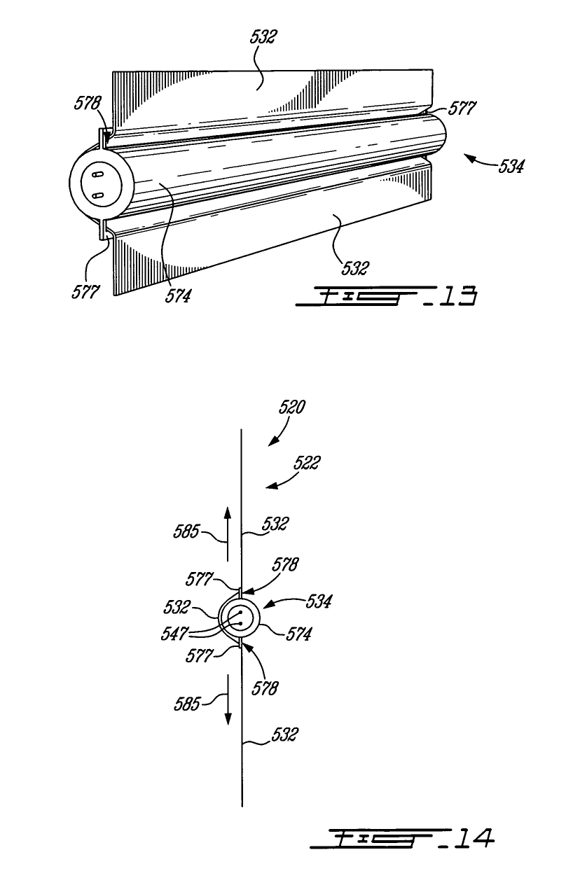

Referring now to FIG. 14, it will be seen that, in an embodiment, the flexible material strip 532 can be continuous along the panel 522. For mounting a light connector strip 534 to the flexible material strip 532, the flexible material strip 532 is first inserted into a first groove 578 of the light connector strip 534. Then, the flexible material strip 532 surrounds the tube 574 of the light connector strip 534 and is inserted into a second groove 578 of the light connector strip 534. Therefore, the position of the light connector strip 534 is adjustable in accordance with the user's needs by sliding the light connector strip 534 along the panel 522 (arrows 585 in FIGS. 11 and 14). Moreover, the number of light connector strips 534 along the panel 522 can also be easily modified by inserting or removing light connector strips 534 from the flexible material strip 532. With the embodiment shown in FIG. 14, the light emitted by the light sources 524 is shed on only one side of the module 520.

The embodiment of FIG. 15 differs from the embodiment of FIG. 14 in that the light emitted by the light sources 524 is shed on both sides of the module 520. To constitute the panel 522, two distinct flexible material strips 532 are assembled together through a light connector strip 534. The flexible material strips 532 are connected respectively to opposed connection flanges 577 of the light connector strip 534. Each flexible material strip 532 defines a bight (U-shaped loop) around one connection flange 577, i.e. it has a first length 579a which extends into the groove 578 of the connection flange 577 and a second length 579b which exits from the groove 578 and extends parallel to the first length 579a. If the length of the flexible material strip 532 can be adjusted, the length of the resulting panel 522 and the position of the light source 524 along the panel 522 can be modified. For example, to adjust the length of the flexible material strips 532, fasteners such as Velcro™ or pins can be used. Moreover, it is possible to add or remove combinations of flexible material strips 532 and light connector strips 534 to adjust the length of the panel 522 and the intensity of the light shed from the module 520 in accordance with the user's needs.

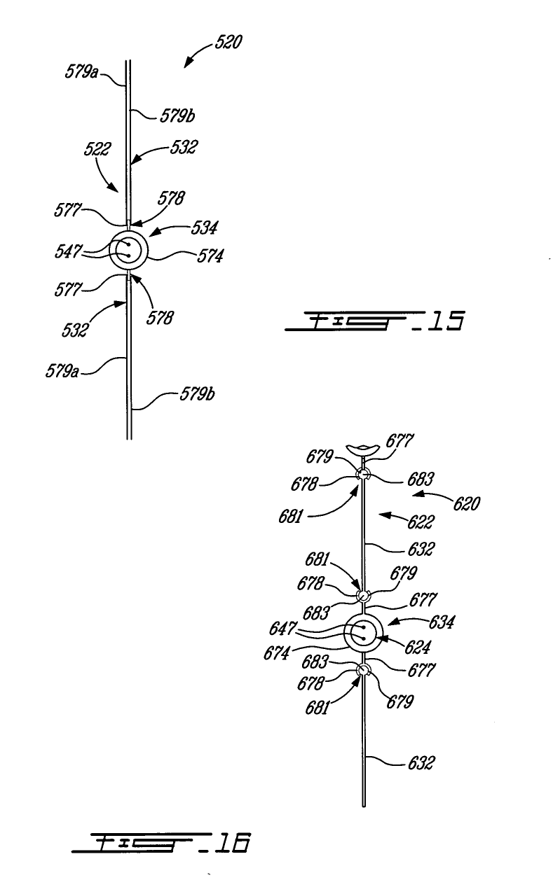

FIG. 16 shows an alternative embodiment of a combination flexible material strip 632 and light connector strip 634 wherein the light emitted by the light sources 524 is shed on both sides of the module 620. In this embodiment, the features numbered with reference numerals in the 600 series correspond to the reference numerals of the previous embodiments.

Like the light connector strip 534, the light connector strip 634 includes a tube 674 defining a channel therein in which the light source 624, such as a fluorescent tube, can be mounted. The light connector strip 634 includes two opposed connection flanges 677 extending outwardly relatively to the tubes 674. The connection flanges 677 have a female member 678 at a free distal end thereof. The female member 678 defines a channel 679 therein and has an aperture 681 providing communication between the exterior of the female member 678 and the channel 679.

The flexible material strips 632 include corresponding male members 683 at their free ends for insertion into the channels 679, the flexible material strips 632 extending trough the apertures 681.

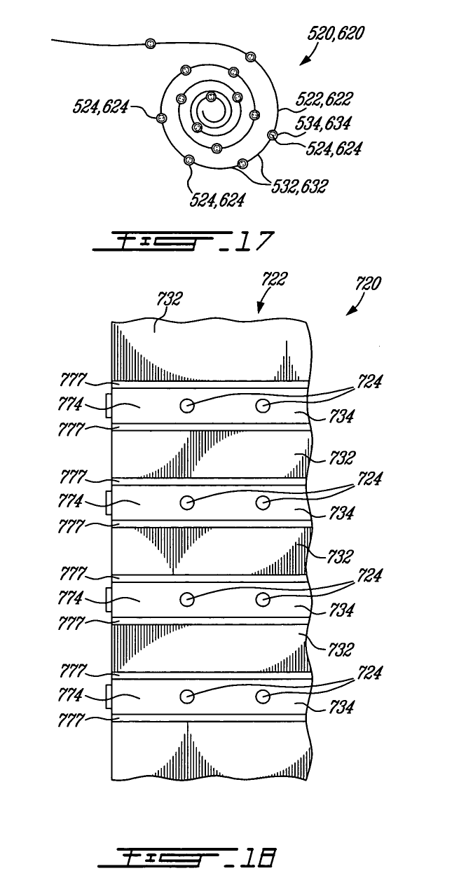

Referring now to FIG. 17, it will be seen that the lighting modules 520, 620 can be rolled or folded into the compact, folded, or rolled position for transport and storage purposes.

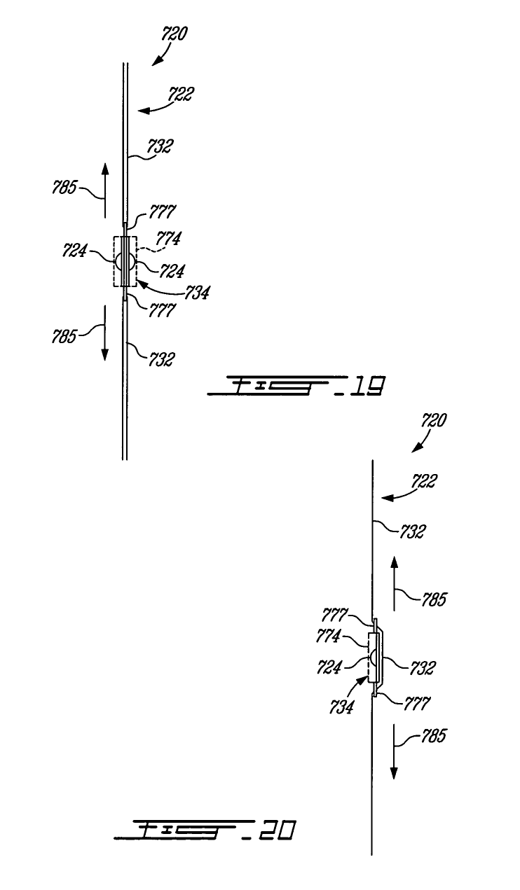

Referring now to FIGS. 18 and 19, it will be seen another embodiment of the foldable lighting module 20, 120, 220, 320, 420, 520, 620 wherein the features are numbered with reference numerals in the 700 series which correspond to the reference numerals of the previous embodiments.

In this embodiment, the light connector strips 734 include the LEDs as light sources 724 instead of fluorescent tubes. Accordingly, the shape of the tubes 774 is modified accordingly.

As for the above described embodiments, the connection flanges 777 of the light connector strips 734 can be adapted to be mounted to a single continuous flexible material strip 732 (FIG. 20), shedding light on only one side of the module 720, or to a plurality of distinct flexible material strips 732 for shedding light on both sides of the module 720 (FIG. 19).

As for the above described embodiments, the shape of the connection flanges 777 can vary in accordance with the user's needs.

The lighting module 20, 120, 220, 320, 420, 520, 620, 720 are rollable/foldable into a stored, folded or compact position and are unrollable into a deployed or operative position for shedding light either on one side or on both sides of the panel 22, 122, 222, 322, 422, 522, 622, 722.

Moreover, the lighting module 20, 120, 220, 320, 420, 520, 620, 720 can be sold as a kit including a panel 22, 122, 222, 322, 422, 522, 622, 722 and light connectors for receiving lights thereto. The panel can be pre-assembled or it can include a plurality of laths 30, 130, 230, 330, 430, 532, 534, 632, 634, 732, 734 or strips that have to be assembled together to define the panel 22, 122, 222, 322, 422, 522, 622, 722.

The lighting module 20, 120, 220, 320, 420, 520, 620, 720 is adapted to be disposed either on a stand or on a wall. Therefore, eyelets (not shown) or any other appropriate fastening equipment that can be used to dispose the panel 22, 122, 222, 322, 422, 522, 622, 722 on a wall. If a stand is used, the panel 22, 122, 222, 322, 422, 522, 622, 722 is self-supporting when deployed. The stand can be demountable, compact and light, to facilitate its transportation with the module.

A person skilled in the art will appreciate that the foldable lighting module 20, 120, 220, 320, 420, 520, 620, 720 can be used as a light source in several applications. For example, without being limitative, it can be used in photography for providing a transportable light source whose light intensity can be easily adjusted. It can also be used in greenhouses, roadside assistance, construction, emergency services and the like as an adjustable light source.

In the embodiments described above, the panel 22, 122, 222, 322, 422, 522, 622, 722 is in a substantially flat position in the deployed or operative configuration. However, a person skilled in the art will appreciate that the panel 22, 122, 222, 322, 422, 522, 622, 722 can be in a different position, such as non-rectilinear configuration, in the deployed or operative configuration. For example, without being limitative, the panel can be wrapped around a column to provide lighting on all sides during a video shoot.

The foldable lighting module can be easily mass manufactured with well-known and established manufacturing techniques.

It will be understood that numerous modifications thereto will appear to those skilled in the art. For instance, the panel can have more than one fluorescent, LED or bulb on a lath. The panel could be a single piece of plastic on which a lightening system is mounted and that can be folded when not used and deployed when in use. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

1. A foldable module adapted to be illuminated, said foldable module comprising:
a foldable panel having a folded position allowing said panel to be stored and transported and a deployed position; and
at least one light source mounted to said panel for shedding light, said at least one light source remaining on said foldable panel in said folded and deployed positions.

2. A foldable module in accordance with claim 1, wherein the foldable panel comprises:
a plurality of laths, each lath having two transversal edges, at least one transversal edge of one lath being hingedly connected to a transversal edge of an adjacent lath allowing the hingedly connected laths to articulate relative to one another so as to position the panel in one of the folded position and the deployed position.

3. A foldable module in accordance with claim 2, wherein the laths are engageable and disengagable from one another to modify the length of the foldable panel.

4. A foldable module in accordance with claim 1, comprising at least one light connector mounted to the foldable panel for mounting the at least one light source thereto.

5. A foldable module in accordance with claim 2, wherein the at least one of the laths is light source equipped and at least one of the laths is light source free.

6. A foldable module in accordance with claim 1, wherein the foldable panel comprises at least one flexible material sheet.

7. A foldable module in accordance with claim 6, wherein the flexible material sheet is continuous along the length of the foldable panel and the foldable module comprises at least one light connector, displaceable along the flexible material sheet, for mounting the at least one light source thereto.

8. A foldable module in accordance with claim 6, wherein the foldable panel comprises at least two flexible material sheets connected to one another through at least one light connector.

9. A foldable module in accordance with claim 1, comprising at least one display poster connector for removably mounting a display poster on the panel in the deployed position.

10. A foldable module in accordance with claim 9, wherein the at least one light source is positioned between the panel and the display poster.

11. A foldable module in accordance with claim 1, wherein the foldable panel in the deployed position is substantially flat.

12. A method to display a poster, comprising:
extending a lighting module including a pliable panel with at least one light source mounted thereto from a compacted position to a deployed position exposing the at least one light source;
mounting a display poster on the lighting module in the deployed position; and
connecting the at least one light source to a power supply for illuminating the display poster mounted to the lighting module.

13. A method for lightening an area, comprising:
extending a lighting module including a pliable panel with at least one light source mounted thereto from a compacted configuration to an operative configuration exposing the at least one light source; and
connecting the at least one light source to a power supply for shedding light from lighting module.

14. A method in accordance with claim 13, wherein the pliable panel comprises a plurality of laths connectable and disconnectable to one another, the method comprising the step of: adjusting lightening intensity by one of connecting to the pliable panel at least one lath having at least one light source mounted thereto and disconnecting from the pliable panel at least one lath having at least one of the at least one light source mounted thereto.

15. A method in accordance with claim 13, wherein the pliable panel comprises a plurality of laths connectable and disconnectable to one another, the method comprising the step of: adjusting the length of the pliable panel by one of connecting to the pliable panel at least one lath and disconnecting from the pliable panel at least one lath.

16. A foldable lighting kit, comprising: at least two laths connectable to one another and defining, when connected together, a compactable panel movable between a compacted position and a deployed position; and at least one light connector mounted to the compactable panel and movable therewith between the compacted position and the deployed position.

17. A foldable lighting kit in accordance with claim 16, wherein each one of the at least two laths comprises a first edge and a second edge, opposed to the first edge, the first edge of a first lath being connectable to the second edge of a second lath to define the compactable panel.

18. A foldable lighting kit in accordance with claim 16, comprising at least one display poster connector for removably mounting a display poster to the compactable panel in the deployed position.

19. A foldable lighting kit in accordance with claim 16, comprising at least one light equipped lath and at least one light free lath.

20. A foldable lighting kit in accordance with claim 16, wherein at least one of the laths comprises a flexible material sheet.

21. A foldable lighting kit in accordance with claim 16, wherein at least two of the laths comprises a flexible material sheet, the at least two laths comprising the flexible material sheets being connected to one another through at least one light connector lath.

22. A foldable lighting kit in accordance with claim 16, wherein the at least two laths are engageable and disengageable from one another to modify the length of the compactable panel.

23. A foldable lighting kit in accordance with claim 16, wherein the at least one light connector is displaceable along the length of the compactable panel.

24. A foldable lighting kit in accordance with claim 16, comprising at least one light operatively connected to at least one of the light connectors, the at least one light remaining on the compactable panel in the compacted position and in the deployed position.

25. A lighting module comprising a rollable panel having at least one light connector mounted thereto and being rollable onto itself for storage and transportation purposes and unrollable in an operative configuration exposing the at least one light connector.

26. A lighting module in accordance with claim 25, wherein the rollable panel comprises a plurality of laths connected to one another.

27. A lighting module in accordance with claim 26, wherein the laths are removably connected to one another.

28. A lighting module in accordance with claim 26, wherein at least one of the at least one light connector is mounted to one of the laths and at least one of the laths is light connector free.

29. A lighting module in accordance with claim 26, wherein each one of the laths comprises a first edge and a second edge, opposed to the first edge, the first edge of a first lath being connected to the second edge of a second lath to define the rollable panel.

30. A lighting module in accordance with claim 25, comprising at least one display poster connector for removably mounting a display poster to the rollable panel in the operative configuration.

31. A lighting module in accordance with claim 25, comprising at least one light operatively connected to at least one of the light connectors, the at least one light remaining on the rollable panel in a rolled configuration and in the operative configuration.

32. A lighting module in accordance with claim 25, wherein the rollable panel comprises a flexible material sheet.

33. A lighting module in accordance with claim 32, wherein the flexible material sheet is continuous along the length of the rollable panel and the at least one light connector is displaceable along the flexible material sheet.

34. A lighting module in accordance with claim 32, wherein the rollable panel comprises at least two flexible material sheets connected to one another through at least one light connector lath.

35. A lighting module in accordance with claim 25, wherein the at least one light connector is displaceable along the rollable panel.

36. A lighting module in accordance with claim 25, wherein the rollable panel is substantially flat in the operative configuration.
